(19) United States
(12) Patent Application Publication
(10) Pub. No.: US 2003/0065734 A1
(43) Pub. Date: Apr. 3, 2003

(54) Method and apparatus for an integrated computer and PDA

(76) Inventor: Sundaram Ramakesavan, Chandler, AZ (US)

Correspondence Address: Glenn E. Von Tersch, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/969,981

(22) Filed: Sep. 29, 2001

(51) Int. Cl. G06F 15/16

(52) U.S. Cl. 709/211; 709/248

(57) ABSTRACT

A method and apparatus relating to an integrated computer system and PDA is disclosed. In one embodiment, the invention is an apparatus. The apparatus includes a computer system and a PDA. The computer system includes a first processor, a first memory coupled to the first processor, a first display controller coupled to the first processor, and a first display coupled to the first display controller. The computer system selectively includes the PDA. The PDA includes a second processor, a second memory coupled to the second processor, a second display controller coupled to the second processor, and a second display coupled to the second display controller. The second processor is selectively coupled directly to the first processor to operate as a multi-processor system.

### BACKGROUND OF THE INVENTION

1. Field of the Invention

This invention generally relates to computer systems and more specifically relates to combination computer and handheld device systems.

2. Description of the Related Art

While consumer computer systems currently exist with single processors, advances in software are starting to lead to potential uses for consumer computers with multiple processors. However, packing multiple processors into a standard computer such as a desktop or laptop model tends to increase prices and design constraints. Moreover, this means that when the computer is idle, two (or more) processors are idle even though the processors are capable of handling tasks.

At the same time, handheld devices such as PDAs have increased in popularity immensely. Such devices include a processor typically, but those processors tend to be lower-power devices than processors found in computer systems. As software demands on PDAs increase, higher-power (computing power) processors for PDAs are likely to become more popular.

Additionally, PDAs typically are designed to be synchronized with computer systems, for purposes of maintaining coherent data in both a database in the PDA storage and in the computer system storage. The interface for such synchronization is often relatively slow. Thus, finding a common improvement that addresses all of these concerns may be advantageous.

### BRIEF DESCRIPTION OF THE DRAWINGS

The present invention is illustrated by way of example and not limitation in the accompanying figures.

FIG. 1A illustrates an embodiment of a computer system.

FIG. 1B illustrates an embodiment of a PDA.

FIG. 2 illustrates an embodiment of a laptop-PDA combination.

FIG. 3A illustrates an alternate embodiment of a laptop-PDA combination.

FIG. 3B illustrates another alternate embodiment of a laptop-PDA combination.

FIG. 4 illustrates yet another alternate embodiment of a laptop-PDA combination.

FIG. 5A illustrates an embodiment of a detached PDA.

FIG. 5B illustrates an alternate embodiment of a detached PDA.

FIG. 6 illustrates an embodiment of a combined laptop and PDA.

FIG. 7 illustrates an embodiment of a process of operating a PDA of a laptop-PDA combination.

FIG. 8 illustrates an embodiment of a process of operating a laptop-PDA combination.

FIG. 9A illustrates an embodiment of memory in a laptop-PDA combination.

FIG. 9B illustrates an alternate embodiment of memory in a laptop-PDA combination.

### DETAILED DESCRIPTION

A method and apparatus related to integrated computer and PDA is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

A method and apparatus relating to an integrated computer system and PDA is disclosed. In one embodiment, the invention is an apparatus. The apparatus includes a computer having a processor and a memory coupled to the processor; and a PDA having a processor and a memory coupled to the processor. The PDA is selectively coupleable to the computer to allow operation of the processor of the PDA and the processor of the computer as a single multi-processor computer. Note that a first device may be selectively coupleable to a second device when the first device may either exist independently of the second device, or the first device and the second device may be coupled together. Further, note that a first object may be coupled to a second object directly, such as by joining a part of the first object to a part of the second object, or indirectly through a third object. An indirect coupling may also be accomplished by way of a link between the first object and the second object through a medium (such as air or electromagnetic waves for example) between the first object and the second object.

In an alternate embodiment, the invention is an apparatus. The apparatus includes a computer system and a PDA. The computer system includes a first processor, a first memory coupled to the first processor, a first display controller coupled to the first processor, and a first display coupled to the first display controller. The computer system selectively includes the PDA. The PDA includes a second processor, a second memory coupled to the second processor, a second display controller coupled to the second processor, and a second display coupled to the second display controller. The second processor is selectively coupled directly to the first processor to operate as a multi-processor system.

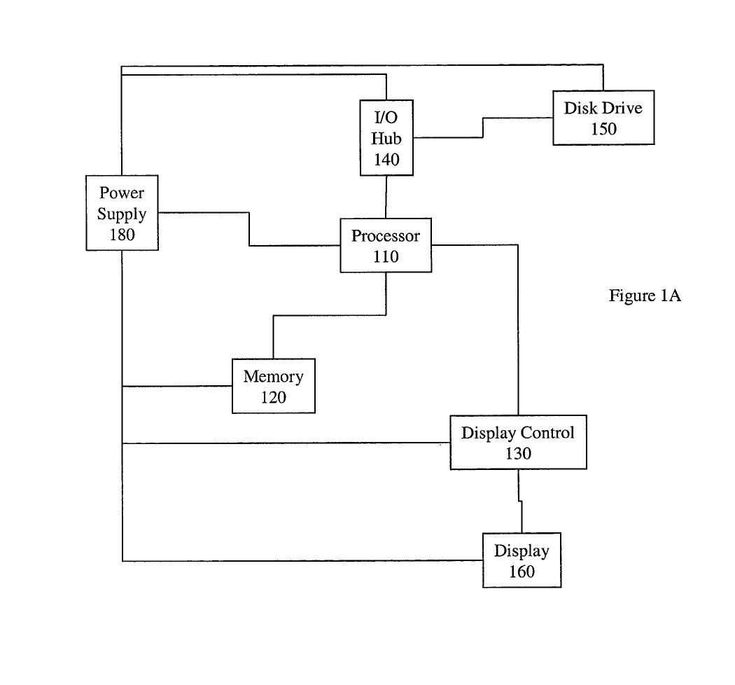

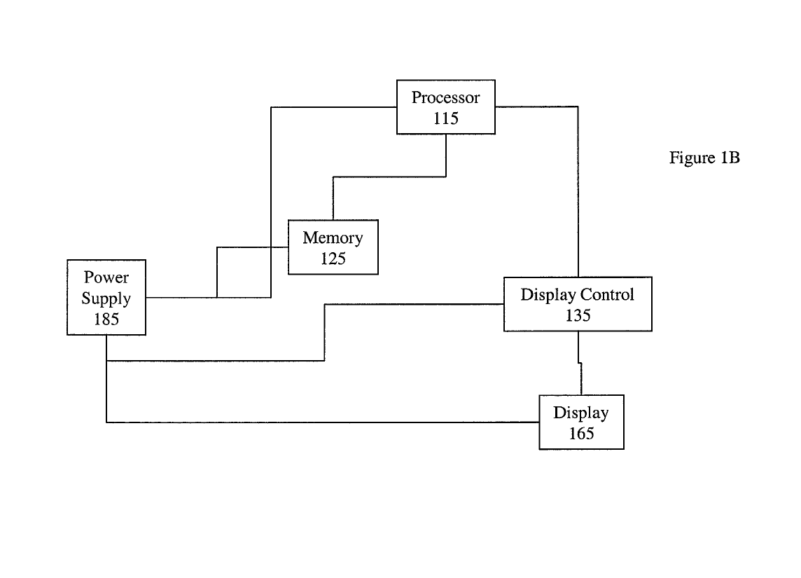

FIG. 1A illustrates an embodiment of a computer system. Processor 110 is coupled to memory 120, display control 130 and I/O interface 140. I/O interface 140 is in turn coupled to disk drive 150 and may be coupled to other I/O devices such as a keyboard, cursor control device, CD-ROM, or other peripheral device for example. Display control 130 is coupled to display 160. Power supply 180 is coupled to each other component, for purposes of supplying power. As will be appreciated, other combinations and arrangements of components are possible, including those which utilize a separate bridge or hub between the processor and other components. However, the general purpose and function of all such computers tends to be similar.

FIG. 1B illustrates an embodiment of a PDA. Note that within the context of the present application, the term PDA has a broad definition, including palmtop devices, handheld devices, wireless and wireline email terminals, and many other similar devices suitable for relatively easy portable use by a consumer. Processor 115 is coupled to display control 135 and memory 125. Display control 135 is coupled to display 165. Power supply 185 is coupled to each of memory 125, display control 135, processor 115 and display 165 for purposes of supplying power to the other components. Note that the same or similar components may be used in both the computer system and the PDA in some embodiments of each.

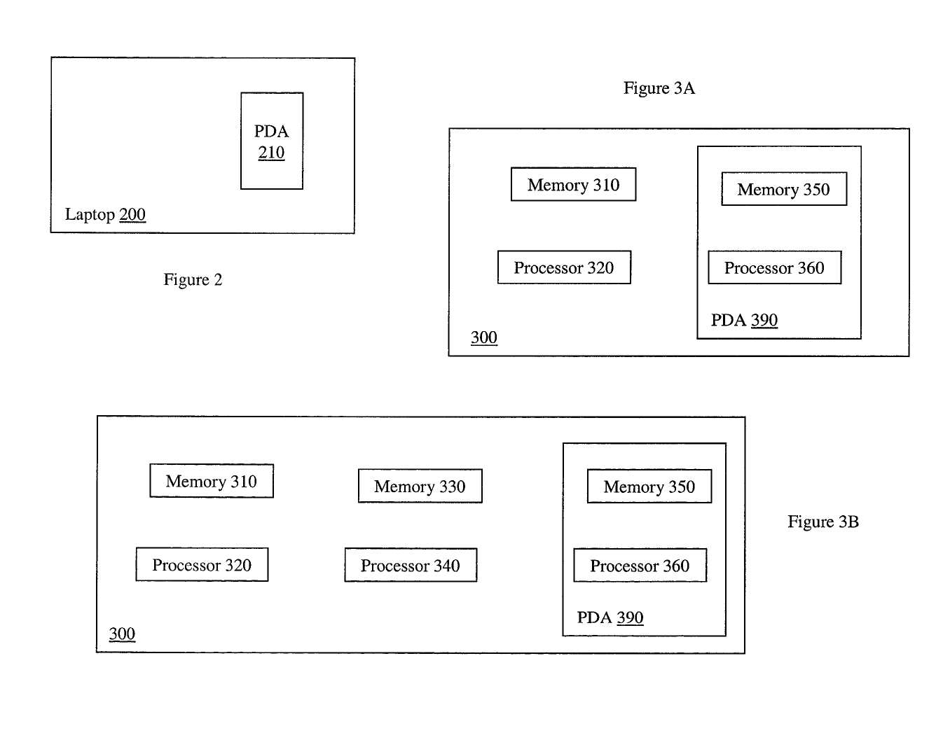

FIG. 2 illustrates an embodiment of a laptop-PDA combination. Laptop 200 includes handheld 210. Note that this may be accomplished by docking handheld 210 into laptop 200 (such as by mating a connector on handheld 210 to a connector on laptop 200 for example) in some embodiments, thereby coupling the independent systems of the two devices. Alternatively, it may be accomplished by otherwise coupling the independent systems of the two devices, such as through a dedicated port and link such as a cable or electromagnetic carrier, or through some disassembly and linking of the two systems.

FIG. 3A illustrates an alternate embodiment of a laptop-PDA combination. Memory 310 and processor 320 are part of the laptop 300 and are not intended to be removable. Memory 350 and processor 360 are part of the PDA 390, and may be removed from the laptop when the PDA is removed. FIG. 3B illustrates another alternate embodiment of a laptop-PDA combination. In this embodiment, processor 340 and memory 330 are intended to be permanently part of the laptop 305.

Note that if PDA 390 is embodied as a single unit, memory 350 and processor 360 will be part of that single unit. In embodiments in which PCA 390 is composed of multiple units, one of those units may include both processor 360 and memory 350, or processor 360 may be part of a first unit and memory 350 may be part of a second unit.

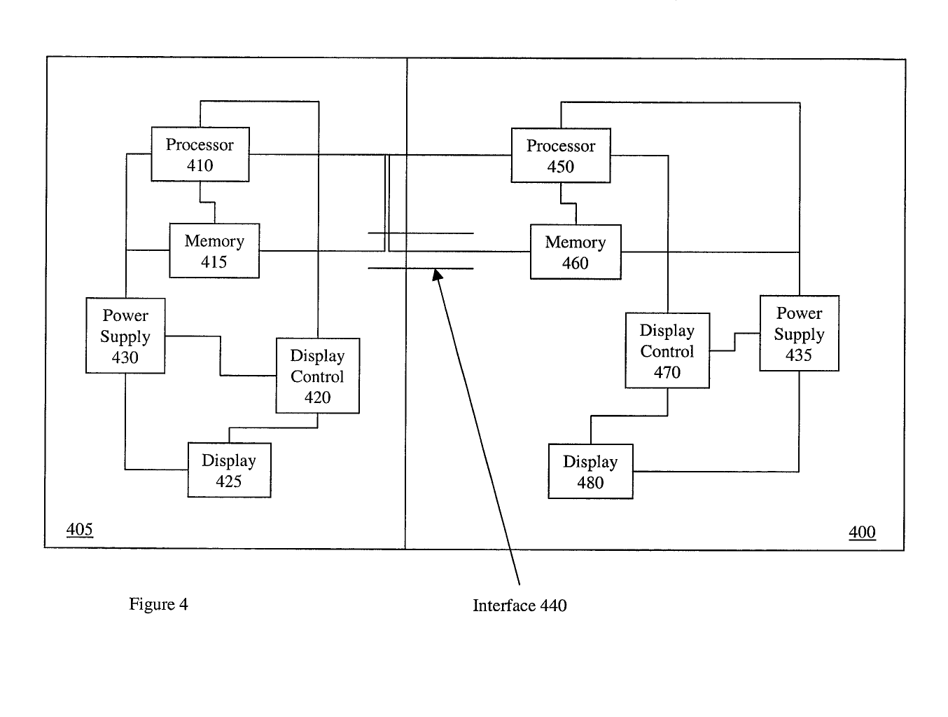

FIG. 4 illustrates yet another alternate embodiment of a laptop-PDA combination. Laptop 400 is divided into a laptop portion and a PDA 405 portion. PDA 405 includes first processor 410, first memory 415 (which is coupled to first processor 410), PDA display control 420 (also coupled to first processor 410), PDA display 425 (coupled to control 420), and PDA power supply 430 (coupled to all of the components of the PDA 405. Also included in laptop 400 is interface 440 which is selectively coupled to first processor 410 and first memory 415. When PDA 405 is detached, the selective coupling to interface 440 decouples. Laptop 400 also includes second processor 450 (coupled to interface 440), memory 460 (also coupled to interface 440 and to second processor 450), laptop display control 470 (coupled to second processor 450) and display 480 (coupled to display control 470). Power supply 435 is also included, and supplies power to all of the other components, either directly or through interface 440 for the components of PDA 405.

Note that during operation of the PDA 405 in conjunction with laptop 400, PDA display control 420, PDA display 425 and PDA power supply 430 are all disabled, and power flows through interface 440. When PDA 405 is detached, it controls display 425 through display control 430 and powers all components from power supply 430. In some embodiments, power supply 430 may include a rechargeable battery which may be recharged by coupling to power supply 435.

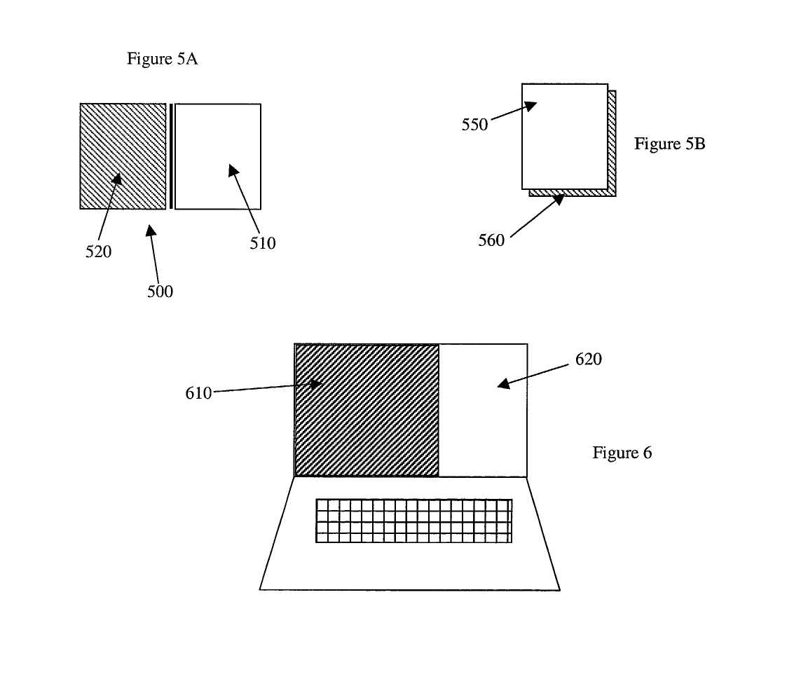

FIG. 5A illustrates an embodiment of a detached PDA. Note that display 510 is attached via a hinge (and connector) to PDA component housing 520. PDA component housing 520 may be expected to house the remaining components of PDA 500. FIG. 5B illustrates an alternate embodiment of a detached PDA. Display 550 is attached via snap connections to the face of component housing 560, with a connector providing electrical connections between the two. Note that the connector and snap connections are not illustrated, as it will be appreciated that these may be implemented as hidden or visible features in a variety of ways all well-known in the art.

FIG. 6 illustrates an embodiment of a combined laptop and PDA. Display 610 is the laptop display, and display 620 is a PDA display which may be used as part of the laptop display 610 when operating as an integrated unit. Similarly, the corresponding PDA processor and memory are available for use when operating as an integrated unit.

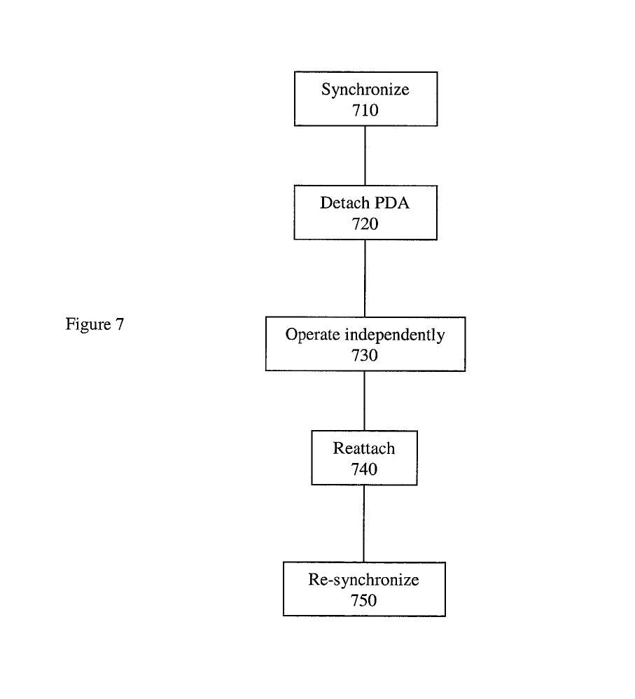

FIG. 7 illustrates an embodiment of a process of operating a PDA of a laptop-PDA combination. At block 710, the laptop and PDA are synchronized, that is to say that data is exchanged between the two subsystems to maintain coherency between them. At block 720, the handheld is detached, allowing for independent operation (and potentially independent operation of the laptop). At block 730, the PDA is operated independently. At block 740, the PDA is reattached to the laptop, either by docking or by directly coupling the PDA components to the laptop components or by other methods of attaching. At block 750, the contents of the PDA memory and the laptop memory are synchronized again.

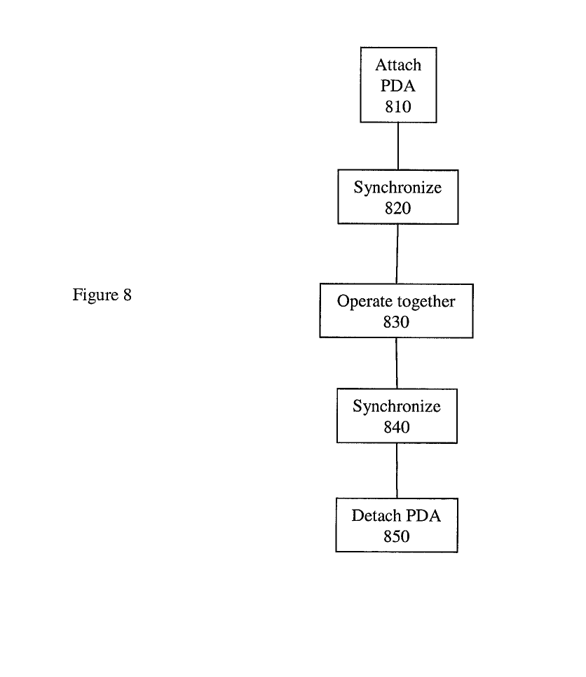

FIG. 8 illustrates an embodiment of a process of operating a laptop-PDA combination. At block 810, a PDA is attached to a corresponding laptop. At block 820, memory of the PDA is synchronized with memory of the laptop. At block 830, the laptop-PDA combination is operated as a single device. At block 840, memory is synchronized again. At block 850, the PDA is detached from the laptop for independent operation.

As will be appreciated, in some embodiments, memory is kept synchronized throughout operation as a combination, by reflecting changes in both sets of memory. In other embodiments, no synchronization is necessary because only the PDA memory stores PDA-related data and software. Furthermore, in some embodiments, synchronization automatically updates PDA software as well as data.

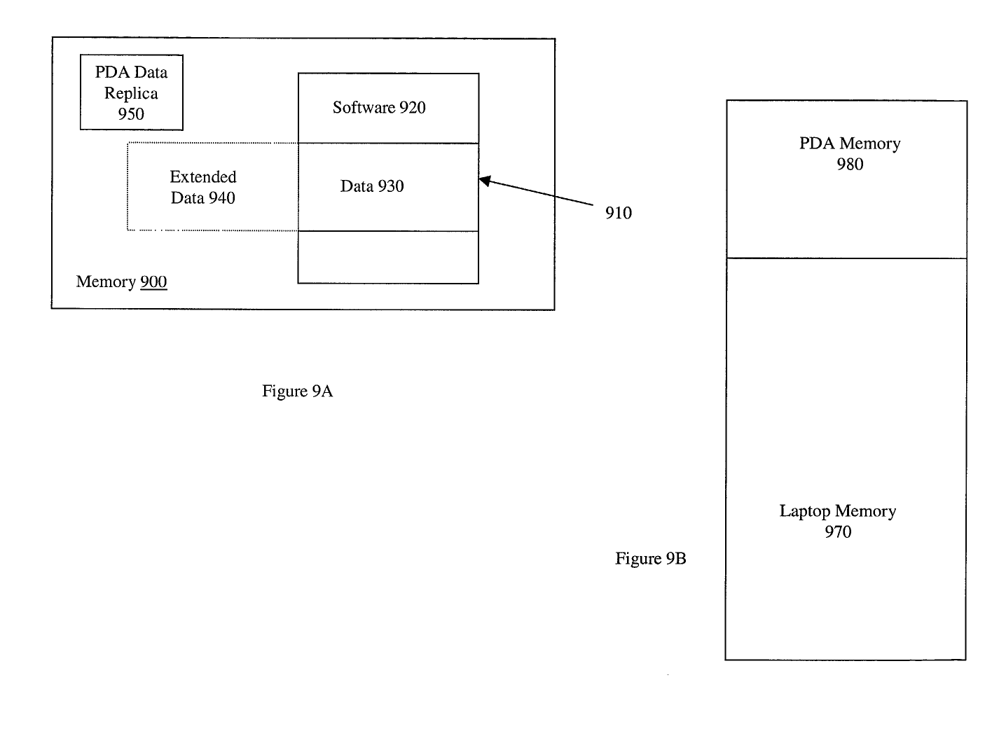

FIG. 9A illustrates an embodiment of memory in a laptop-PDA combination. Memory 900 includes PDA memory (buffer) 910 and additional memory. PDA memory 910 includes PDA software 920 and PDA data 930, along with an additional buffer zone which may expand or shrink. In memory 900, extended data 940 is also included, which has data corresponding to PDA data 930 but including different or additional information. Also, PDA data replica 950 is present in memory 900 for purposes of synchronization with PDA data 930.

FIG. 9B illustrates an alternate embodiment of memory in a laptop-PDA combination. Laptop memory 970 and PDA memory 980 are memory mapped. Data, code (programs) and anything else suitable for storage in memory may be stored at any location. Housekeeping is performed at attachment and deattach times to properly organize memory for each subsystem (PDA and laptop).

Note that operation as a multi-processor system includes operation of the two (or more) processors in tandem to accomplish a single task other than synchronizing data between memory of the PDA and of the computer system. Thus, a single task might include calculating values for a spreadsheet, processing data received from a network connection, processing data from a CD-ROM drive, or other similar tasks. Furthermore, note that much of the discussion has related to laptop computers, but this is clearly exemplary and illustrative, rather than limiting on the scope and spirit of the invention.

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 4 may be integrated into components, or may be subdivided into components. Similarly, the blocks of FIG. 8 (for example) represent portions of a method which, in some embodiments, may be reordered or may be organized in parallel rather than in a linear or step-wise fashion. The present specification and figures are accordingly to be regarded as illustrative rather than restrictive.

What is claimed is:

1. An apparatus comprising:
a computer system including:
a first processor;
a first memory coupled to the first processor;
a first display controller coupled to the first processor;
a first display coupled to the first display controller;
and the computer system selectively including PDA, the PDA including:
a second processor;
a second memory coupled to the second processor;
a second display controller coupled to the second processor;
a second display coupled to the second display controller;
and wherein the second processor is selectively coupled directly to the first processor to operate as a multi-processor system.

2. The apparatus of claim 1 further comprising:
a control hub coupled to the first processor and to the first memory and to the first display controller, the control hub to control data flow between the first processor and the first memory, the control hub to control data flow between the first processor and the first display controller, the first memory coupled through the control hub to the first processor, the first display controller coupled through the control hub to the first processor.

3. The apparatus of claim 1 wherein:
the computer system further including a first power supply, the first power supply coupled to each of the first processor, first memory, first display, and first display controller, and the first power supply selectively coupled to each of the second processor, and the second memory;
and the PDA further including a second power supply, the second power supply selectively coupled to each of the second processor, second memory, second display, and second display controller.

4. The apparatus of claim 3 wherein:
the second power supply selectively coupled to the first power supply, the second power supply to receive power from the first power supply.

5. A computer system comprising:
a first processor;
a first memory coupled to the first processor;
a first display controller coupled to the first processor;
a first display coupled to the first display controller;
a connector disposed to selectively connect components of a selectively coupled PDA to the first processor.

6. The computer system of claim 5 further comprising:
a first power supply, the first power supply coupled to each of the first processor, first memory, first display, and first display controller, and the first power supply connected to the connector to selectively supply power to the selectively coupled PDA.

7. The computer system of claim 6 wherein:
the connector including a conductor to supply a signal to the selectively coupled PDA to allow the selectively coupled PDA to deactivate components of the selectively coupled PDA.

8. A PDA comprising:
a first processor;
a first memory coupled to the first processor;
a first display controller coupled to the first processor;
a first display coupled to the first display controller;
a connector to selectively connect the first processor directly to a control hub of a computer system.

9. The PDA of claim 8 wherein:
the connector to selectively connect the first memory directly to the control hub of the computer system.

10. The PDA of claim 8 wherein:
the connector to selectively connect the first memory directly to a second processor of the computer system.

11. The PDA of claim 8 wherein:
the connector to selectively connect the first processor directly to a first conductor of the computer system, the first conductor to supply a signal, the processor to disable components of the PDA responsive to the signal.

12. A method comprising:
synchronizing a computer system with a PDA, the PDA directly connected to a processor of the computer system;
detaching the PDA from the computer system;
activating a display of the PDA responsive to the detaching.

13. The method of claim 12 further comprising:
activating a power supply of the PDA responsive to the detaching.

14. The method of claim 12 further comprising:
modifying contents of memory within the PDA;
reattaching the PDA to the computer system, the PDA directly connected to the processor of the computer system;
synchronizing contents of memory within the PDA with a memory of the computer system.

15. The method of claim 14 further comprising:
operating the PDA and the processor of the computer system as a multi-processor computer.

16. The apparatus of claim 1 wherein:
the second processor is selectively coupled to the first processor through a means for connecting the computer system to the PDA.

17. The apparatus of claim 16 wherein:
the means for connecting is a first connector of the computer system and a second connector of the PDA, the first connector to mate with the second connector.

18. The apparatus of claim 1 wherein:
the second processor is selectively coupled to the first processor through a first connector of the computer system and a second connector of the PDA, the first connector to mate with the second connector, the first connector coupled to the first processor, the second connector coupled to the second processor.

19. An apparatus comprising:
a computer having a processor and a memory coupled to the processor;
a PDA having a processor and a memory coupled to the processor; and
wherein the PDA is selectively coupleable to the computer to allow operation of the processor of the PDA and the processor of the computer as a single multi-processor computer.

20. The apparatus of claim 19 wherein:
the PDA is further selectively coupleable to the computer to allow operation of the memory of the PDA and the memory of the computer as a single memory-mapped set of memory.

21. The apparatus of claim 19 wherein:
the PDA is further selectively coupleable to the computer to allow access to the memory of the PDA and the memory of the computer by the processor of the computer and the processor of the PDA.

22. The apparatus of claim 19 wherein:
the PDA further includes a power supply and the computer further includes a power supply and wherein the PDA is selectively coupleable to the computer to recharge the power supply of the PDA from the power supply of the computer.

23. The apparatus of claim 19 wherein:
the PDA having a display and the computer having a display.

24. The apparatus of claim 23 wherein:
the display of the PDA selectively coupleable to the display of the computer.

25. The apparatus of claim 23 wherein:
the display of the PDA selectively coupleable to a display controller of the computer.

26. The apparatus of claim 23 wherein:
the PDA to disable the display of the PDA responsive to coupling to the computer.
